(19) United States
(12) Patent Application Publication
(10) Pub. No.: US 2023/0240171 A1
(43) Pub. Date: Aug. 3, 2023

(54) Soil Cultivation Arrangement For Producing A Seed Furrow

(71) Applicant: Marian Ivanov Dichevski, Varna (BG)

(72) Inventor: Marian Ivanov Dichevski, Varna (BG)

(21) Appl. No.: 17/625,252

(22) PCT Filed: Jul. 8, 2019
(86) PCT No.: PCT/EP19/68252

§ 371 Date: Apr. 27, 2022

(51) Int. Cl. A01C 5/06; A01B 49/02

(52) U.S. Cl. CPC A01C 5/064; A01B 49/022

(57) ABSTRACT

The invention relates to a soil cultivation arrangement (100) for the agricultural cultivation of a soil (500), in particular a field and/or arable land, with a carrier device for attaching to an agricultural tractor and with one or more soil cultivation units (200, 201, 202, 203) for preparing and/or generating a seed furrow (530), which soil cultivation units (200, 201, 202, 203) as modular components of the soil cultivation arrangement (100), can be connected to the carrier device and/or to a sowing unit that can be towed by the agricultural tractor and can be arranged along the carrier device in the desired sequence.

The invention relates to a soil cultivation arrangement for agricultural cultivation of a soil, in particular a field and/or arable land, with a carrier device for attachment to an agricultural tractor, in particular a tractor or a tug, and with one or more soil cultivation units for preparation and/or for generating a seed furrow, which soil cultivation units as modular components of the soil cultivation arrangement can be connected to the carrier device and/or to a sowing unit towable by an agricultural tractor and can be arranged along the carrier device in the desired sequence.

In industrial agriculture, soil cultivation is one of the most costly and time-consuming work processes in field or arable farming. In addition to intensive, turning soil cultivation, plowing, in which the soil of a field and/or arable area is turned and loosened in the uppermost, approx. 40 cm thick soil layer, gentler soil cultivation methods have now also become established on a large industrial scale. In the so-called no-plowing or non-plowing (also known as “no-till”) soil cultivation methods, only superficial soil cultivation takes place. After the harvest, straw and crop residues can remain on the surface of the soil until the next sowing, thus protecting the soil from water and wind erosion and evaporation of soil moisture. For such conservation soil cultivation methods, however, fundamentally different demands are made on the technology. Despite the protective and conserving properties, straw, plant and root remains on the field or arable land or in the soil can prevent precise seed placement or represent a mechanical resistance for the seed, resulting in insufficient seed-to-soil contact.

Particularly in connection with the so-called single seed or single grain placement, in which the seed is placed single grain by grain along a prepared seed furrow after previous separation (e.g. by means of mechanical or pneumatic grain separation), insufficient seed-to-soil contact can lead to a considerable reduction in the harvest yield. Special soil cultivation devices for the non-plowing soil cultivation in connection with the single sowing or single grain depositing are designed to open or loosen the soil as well as to chop up straw and harvest residues, in particular to cut them and mix them effectively into the uppermost soil horizon. Such soil cultivation devices are usually built up from a series of different, mostly disk-shaped, tool elements with different functions.

Various combinations of such tool elements are known from the prior art. For example, EP 0 849 426 B1 discloses a sowing unit with an arm which is attached at a front-end region to a tool carrier of a tractor and is designed to accommodate various tool elements. The so-called furrow opener forms the essential part of the sowing unit. It represents an inclined and spring-mounted single disc that is pulled by the tractor in the forward direction of travel to create a seed furrow. To determine the depth of penetration of the furrow opener and the resulting furrow depth, a depth wheel is arranged near the leading side of the furrow opener. The depth wheel also serves to compact and stabilize the furrow wall. The seed is then released into the opened furrow by means of a coulter. The furrow opener is preceded by a furrow clearer (also known as “raw cleaner”) to remove plant and crop residues on the ground from the area in front of the furrow opener. The furrow clearer essentially consists of two disks that are positioned at an angle to each other, the circumference of which is provided with a tooth profile. Arranged following the furrow opener, a closing wheel rolls on the surface of the soil, which loosens the soil in the area of the furrow wall to close the previously opened furrow and at the same time presses against the seed lying in the furrow.

The furrow clearer described in EP 0 849 426 B1 works essentially above ground, i.e. clears straw and harvest residues above the soil surface. By means of a mostly waved, individual soil cultivation disc (also referred to as “coulter” or “disc opener”) can be “cut” into the upper soil horizon in order to chop up grown root residues also underground, i.e. below the surface of the soil, and thus to facilitate the opening of the seed furrow. Such a coulter, if necessary, can be used in addition to or instead of the furrow clearer and is expediently arranged in front of the furrow opener. U.S. Pat. No. 7,992,651 B2 discloses a coulter with a wave-like disk surface. Before opening the actual seed furrow, the coulter should cut or slit the soil to a desired depth in order to loosen up the soil in this area and to separate any remains of plants or roots. Due to the wavy disc surface, the effectively cut or slotted and loosened soil area is wider than the actual thickness of the disc. According to different embodiments, the coulter can be provided with a cutting edge formed on one or both sides along its circumference.

A tool arm for a multi-row planting unit is known from US 2016/0050837 A1, which is pulled by a rural utility vehicle, a tractor or tug, in order to generate a plurality of seed rows arranged parallel to one another and to equip them with seeds. The tool arm is equipped with various tool elements for preparing the soil, for creating the seed furrow, for spreading the seed and for closing the seed furrow. In one embodiment, so-called closing wheels are shown, on the outer circumference of which projections pointing obliquely outward on both sides enlarge the running surface of the closing wheels. As a result, the locking wheels act on the loosely piled soil next to the seed furrow and thus close the seed furrow.

Also from the S.I. Distributing Inc. is a similar locking wheel (https://sidist.com/index.cfm?fuseaction=category. display&category_ID=141&CFID=50302618&CFTOKEN=12808232&CFID=59384229&CFTO KEN=53824749, accessed on May 21, 2019) under the name “Finger-Till Closing Wheel” offered. The locking wheel is designed as a pair of disks with two disks that are positioned at an angle to one another and are each cast in one piece. Each disk comprises two rows of pyramidal projections on the outer circumference of the disk, one row pointing axially inward and the other row pointing radially outward. The axially inwardly pointing projections roll off in the area of the furrow walls in order to close the seed furrow, at the same time the radially outwardly pointing projections ensure loosening of the soil in this area.

However, the devices for conservative soil cultivation shown in the prior art also have disadvantages. This often leads to a compaction of the soil in the area of the seed furrow walls (also referred to as “side-wall-compaction”). Such a compaction of the soil can lead to a predetermined direction of growth of the roots of the sown plants within the seed furrow or along the seed furrow wall and consequently to a lower crop yield. Even the subsequent loosening of the soil in this area by means of appropriately designed closing wheels cannot adequately eliminate the compaction often caused by tool elements running in front, especially when the soil is wet.

It is therefore an object of the present invention to eliminate the disadvantages of the prior art and to create an improved soil cultivation arrangement. This arrangement, in particular, avoids the furrow wall compaction together with an optimized seed-soil contact due to homogeneous soil density in the area of the seed furrow. At the same time, a homogeneous soil density promotes simultaneous germination of the seeds, which further increases the harvest yield.

The object is achieved by a soil cultivation arrangement according to claim 1.

A soil cultivation arrangement according to the invention of the type described in more detail at the beginning is characterized by a modular design, which enables flexible use of different soil cultivation units with different functions. For this purpose, the soil cultivation units can be connected to a carrier device and can be flexibly arranged along the carrier device, if required, in the desired order. In addition or as an alternative, a connection with a sowing unit is also possible. Tool arms known from the prior art or other devices that enable the soil cultivation units to be suspended or fastened are suitable as the carrier device. The soil cultivation units are lined up along the carrier device in order to prepare the soil in the area of an individual seed furrow, to loosen it and finally to generate the seed furrow. Depending on the size of the field and/or arable land to be worked, several soil cultivation arrangements can be attached parallel to one another to a tool carrier of an industrial or agricultural tractor, in particular a tractor or tug, in order to prepare and/or generate a corresponding number of seed furrows.

Advantageously, in the pulling direction of the agricultural tractor, initially a soil cultivation unit for cutting plant and/or root remains and for preparing the soil is arranged. A further soil cultivation unit for preparing the seed furrow and for loosening the soil in the area of the seed furrow to be generated can follow this. Finally, a soil cultivation unit can be provided for generating the seed furrow and at the same time for loosening the soil in the area of the seed furrow wall.

Due to the flexible equipment of the carrier device, depending on the nature of the soil to be worked and the condition of the field and/or arable land, e.g. the type and amount of remaining plants and crops or root remains or the moisture content, a desired combination of soil cultivation units can be modularly created put together. For example, the soil cultivation arrangement, if necessary, can be equipped with one or more of the soil cultivation units. Depending on the type and properties of the soil, it is also possible, for example, to assemble several soil cultivation units arranged in a row, in particular soil cultivation disks with a different penetration depth and/or a different diameter and subsequently also with a mutually different mass, if necessary. It has proven to be advantageous here to design the soil cultivation units arranged foremost with respect to the pulling direction of the agricultural tractor with the smallest penetration depth and/or the smallest diameter, with the penetration depth and/or diameter of further soil cultivation units increasing in opposite of the pulling direction. In the case of soil cultivation arrangements arranged parallel to one another for generating several parallel seed furrows, soil cultivation units which are arranged parallel to one another and have an identical penetration depth and/or an identical diameter are preferably formed in each case at the same position. By means of a suitable, modular arrangement of different soil cultivation units, compaction of the seed furrow, especially in the area of the seed furrow wall, can be prevented immediately before and/or during the seed furrow generation or the soil loosening in the area of the seed furrow wall.

The arrangement according to the invention can be supplemented additionally by further tool elements known from the prior art, such as, for example, a device for depositing the seeds, a furrow clearer or one or more closing wheels, or can be used together with them.

The soil cultivation arrangement according to the invention is particularly well suited for generating seed furrows for individual seeds, but can also be used advantageously for generating seed furrows with different dimensions, in particular for generating seed furrows for smaller seeds such as wheat, rape, barley, etc.

Advantageous embodiments are claimed in the subclaims and are explained in more details below.

Thus, at least one soil cultivation unit of the soil cultivation arrangement in an advantageous embodiment can comprise one or more soil cultivation disks, which are rotatable mounted for rolling on the ground about their respective axis of rotation. The discs are provided with axial loosening pins on at least one outer circular surface facing in particular a seed furrow wall, which loosening pins are provided to loosen the soil in the region of the respective seed furrow wall.

A soil cultivation disc is preferably circular and has two opposing circular surfaces as well as a circumferential or running surface. In operation, i.e. when the agricultural tractor pulls the soil cultivation arrangement in particular on the soil surface and/or partially below the soil surface in the upper soil horizon, the soil cultivation disc rolls along its circumferential or running surface on the ground. This means that the soil cultivation disc penetrates the soil surface or the upper soil horizon by a penetration depth or working depth in order to work the soil. Depending on the arrangement and/or alignment of the soil cultivation discs, e.g. individually or in pairs, either a soil incision intended to prepare the seed furrow or the, in particular V-shaped, seed furrow can be produced in the soil. A circular surface facing the soil or the seed furrow wall, which is in direct contact with the soil, is referred to as the outer circular surface. An inside circular surface, on the other hand, is a circular surface facing away from the ground or soil or the seed furrow wall. In the case of an inclined soil cultivation disc, the circular surface leading in the pulling direction is consequently referred to as the outside, whereas the trailing circular surface is referred to as the inside. If the tillage disc is aligned parallel to the pulling direction, both circular surfaces are usually on the outside.

According to an advantageous embodiment, the soil cultivation disc is provided with axial loosening pins on at least one outer circular surface. The loosening pins are preferably aligned parallel along the axis of rotation of the soil cultivation disc or alternatively form an angle with the axis of rotation. During operation, i.e. when the cultivation disc rolls on the ground, the loosening pins are pulled along a circular arc-shaped curve through the laterally adjacent soil or the seed furrow wall, which loosens the soil in this area of the soil and thus prevents seed furrow wall compaction.

The loosening pins are preferably arranged at a distance in a range between 5 mm and 15 mm, particularly preferably at a distance of 10 mm from the circumferential or running surface and are spaced from one another in a range from 1 cm to 4 cm. The loosening pins are advantageously cylindrical with a diameter in a range from 1 mm to 5 mm and a length in a range from 5 mm to 30 mm. In contrast to the coulters known from the prior art, loosening of the soil can be achieved by means of the loosening pins arranged at a distance from one another, without the soil being transported in the corresponding area.

It is also advantageous if the soil cultivation disc is connected to the loosening pins on the outer circular surface by means of a joining connection and the loosening pins are aligned orthogonally to the outer circular surface.

According to this advantageous embodiment, the loosening pins are each provided as separate components that are joined to the soil cultivation disc by means of a joining process. In particular, the loosening pins can be welded to the soil cultivation disc or fitted and/or pressed in and/or hammered into corresponding recesses in the soil cultivation disc.

In principle, it is possible to form a cutting edge on both circular surfaces of the one or more soil cultivation disks. Easier to manufacture and advantageous for stability, the one or more soil cultivation disks have a one-sided cutting edge which, starting from the outer disk circumference of the respective soil cultivation disk, extends along the outer circular surface in the direction of the axis of rotation of the soil cultivation disk. The cutting edge facilitates penetration into the ground and in particular enables greater penetration or working depths. In addition, the cutting edge can be used to cut plant or crop residues on the soil surface and/or root residues in the upper soil horizon, which enables even better loosening and homogenization of the soil, which also helps to avoid soil compaction in the area of the seed furrow wall. The design of a cutting edge with a width of 5 mm-15 mm, particularly preferably with a width of 10 mm, has proven to be expedient.

Furthermore, an advantageous embodiment of the invention provides that at least one cultivation unit is designed as a furrow opener with two rotatable mounted cultivation disks, in particular sowing disks. Here at least one of the cultivation disks for generating the seed furrow being set at an angle to the pulling direction or the forward travel direction of the rural tractor and its respective, leading outer-side circular surface, preferably in the area on the outer disc circumference, is provided with the loosening pins.

To generate the seed furrow, it is expedient to arrange two soil cultivation disks in pairs as furrow opener, with at least one cultivation disk positioned at an angle to the pulling direction. In a further development, it is particularly advantageous if both soil cultivation discs are inclined to the direction of pull, the soil cultivation discs being aligned at their leading ends, touching one another along a circumferential area of 4 cm to 5 cm and spaced apart from one another at their trailing ends. The angle enclosed by the soil cultivation disks is preferably in a range from 7.5° to 15°, particularly preferably in a range from 10.5° to 11.5°. Due to this alignment of the soil cultivation discs with respect to one another, an axially symmetrical, V-shaped seed furrow can be produced by means of the furrow opener. The seed furrow width is varied by setting the included angle, the seed furrow depth depends on the set penetration or working depth of the furrow opener. The penetration or working depth of the furrow opener can be determined by devices known from the prior art, such as, for example, depth gears or so-called “chicken feet”, and adapted if necessary.

In order to prevent simultaneously the seed furrow walls from compaction during the production of the seed furrow, the soil cultivation discs are provided with the loosening pins on their respective outer circular surfaces associated with the adjacent seed furrow wall. The furrow opener is preferably arranged trailing with respect to the further soil cultivation units and the pulling direction or forward direction of travel of the landscape tractor. In order to place the seeds directly in the generated seed furrow, the furrow opener is expediently equipped with a sowing unit, preferably a device for depositing single grains, or designed as part of such a sowing unit, and is therefore also referred to as a “seeding disc” in English. Optionally, a closing wheel can follow the furrow opener in order to close the generated seed furrow and to cover the seed deposited therein with soil.

According to an advantageous embodiment of the invention, it is also possible that at least one soil cultivation unit is designed as a soil loosening unit with a single rotatable mounted soil cultivation disc. Moreover, this soil cultivation disc for loosening the soil and for preparing the seed furrow at least on one or both of the furrow wall facing outer circular surfaces, is provided with loosening pins. In particular, the loosening pins are arranged in the area of the outer circumference of the soil cultivation disc and/or in the area of the seed furrow to be produced.

Such an individually arranged soil cultivation disc can take over the function of the above-described coulter and slit or cut the soil in the upper soil horizon to the desired penetration or working depth before the seed furrow is produced. At the same time, any root or plant residues that may be in the soil can be broken up and shredded. In addition to the function of a well-known coulter, the soil cultivation disc is provided on both outer circular surfaces with loosening pins, whereby the soil or the ground adjacent to the slot or incision created is loosened at the same time. The loosening pins do not transport the soil. The working or penetration depth of the cultivation disc corresponds either to the working or penetration depth of a trailing furrow opener and is in particular in a range of up to 4 cm-6 cm or exceeds this and is in particular in one range from up to 7 cm-10 cm.

According to a further advantageous variant of the invention, at least one soil cultivation unit has a runner-like sliding device, the underside of which, facing the soil, is designed to slide on the soil surface.

In a further development of this variant of the invention, one or more soil cultivation disks protrude, in particular pass through, the sliding surface of the sliding device by a variably adjustable penetration or working depth.

The sliding device is provided preferably with a sliding surface on the underside, which is aligned parallel to the soil surface and through which the soil cultivation disc passes. For this purpose, the sliding device is designed with a corresponding recess. Alternatively, it is also possible to arrange one or two sliding devices (each) adjacent to the soil cultivation disc. The distance between the underside sliding surface of the sliding device and the area of the soil cultivation disc penetrating into the soil corresponds to the penetration or working depth within which the soil is loosened and/or the seed furrow depth of the seed furrow to be produced. Like the depth wheels or “chicken feet” known from the prior art, the sliding device can thus be used for depth control; the penetration or working depth is variably adjustable.

In a particularly advantageous development, the variant of the invention described above is designed as a pre-cutter with a single rotatable mounted soil cultivation disc, in particular a knife disc. Here the soil cultivation disc for cutting plant and root remains and for preparing the seed furrow is provided along its outer circumferential or running surface with a radially directed tooth profile.

In this development, the sliding device sliding on the soil surface fulfills the additional purpose of holding down plant or harvest residues located there and/or aligning it flat to the soil surface, which facilitates shearing by means of the soil cultivation disc designed as a knife disc. At the same time, it is prevented that the rotating knife disc is pulling out plant or root residues, which are in the soil, i.e. below the surface of the soil that results in a homogeneous mixing of the soil with the plant and/or root residues in it.

Optionally, according to one embodiment of the invention, at least one soil cultivation unit is designed as a movable soil loosening unit with one or more knives. These are used to cut plant and root residues, loosen the soil and prepare the seed furrow to be generated in a translatory manner, in particular transversely, to the pulling direction or the forward direction of travel of the agricultural tractor.

Both the cultivation units designed in the manner of cultivation disks described so far and the cultivation unit designed with one or more knives can be provided with their own drive unit or can be driven externally. The drive unit is preferably designed as an electrically, pneumatically, mechanically or hydraulically driven rotary actuator or linear actuator. Thus, in order to rotate a respective soil cultivation disc in or against the pulling direction or to move the one or more knives in an oscillating “up and down” manner transversely to the pulling direction or forward travel direction of the agricultural tractor. For this purpose, the carrier device of the soil cultivation arrangement can have a holder or fastening option for a corresponding linear actuator, or the linear actuator is correspondingly fastened to a sowing unit.

It is advantageous to rotate one or more soil cultivation discs in the pulling direction of the tractor, preferably at high speed, in order to keep the soil offset, i.e. the mass of soil to be moved, as low as possible. Via an assigned control, the speed and direction of rotation of the actuator-driven rotary movement of the one or more soil cultivation disks can be set as required, regardless of the travel speed and travel direction of the agricultural tractor. The use of an optional sliding device together with the drive unit is advantageous, whereby, for example, the setting of the desired speed and the direction of rotation of the actuator-driven rotary movement are made easier and more precise by reducing the rolling effect on the soil. Alternatively, it is also feasible to do without it.

In order to cut, shear or chop off effectively plant and/or root remains in the soil, the one or more knives move at high speed. For this purpose, the one or more knives are connected to the linear actuator in a manner known from the prior art and are mounted to be linearly movable. The mounting is preferably designed with clearance along the pulling direction and/or along the direction of movement of the knives that is transverse, in particular at a preferably right angle with the soil, or the knives are spring-mounted to compensate the appearance of stones or other inhomogeneity in the soil.

The soil loosening unit designed with one or more knives interacts with the sliding device in the manner described above, wherein, according to an advantageous development, the one or more knives of the soil loosening unit are arranged penetrating an, in particular slot-like, recess of the sliding device and preferably each knife has a respective, in particular slot-like, recess assigned within the sliding device.

The sliding device is intended to hold down plant residues, to improve and ensure the shearing performance and/or cutting performance and to prevent that root or plant residues are pulled out of the ground during the upward movement of the one or more knives.

Additionally or alternatively, according to a further variant of the invention, at least one soil cultivation unit can be designed as a soil-loosening unit with a revolving chain. This chain is actuated by an actuator to cut plant and root residues, to loosen the soil and to prepare the seed furrow to be generated in the manner of a chainsaw formed with a saw tooth profile.

The previously described soil cultivation units can each be connected to a soil cultivation arrangement according to the invention in a modular manner and in the desired sequence. As is known from the prior art, the soil cultivation units are each spring-loaded or connected to the carrier device of the soil cultivation arrangement via corresponding arms and are movably mounted in order to be able to compensate stones or other unevenness in the ground, for example. In addition to the dead weight, continuous contact of the respective running or sliding surfaces with the soil can also be ensured in a manner known from the prior art by setting a pre-tension.

The respective cultivation units are also suitable for retrofitting cultivation arrangements and/or sowing units known from the prior art.

The invention therefore also relates to a furrow opener according to claim 13, a soil loosening unit with one or more knives according to claim 14, a soil loosening unit with a revolving chain according to claim 15 and a pre-cutter according to claim 16, each suitable for connection to a carrier device of a soil cultivation arrangement.

Finally, the invention is also directed to a method for producing a soil cultivation disc for a soil cultivation unit for connection to a carrier device of a soil cultivation arrangement.

According to the invention, the manufacturing method has the following steps:
Provision of a soil cultivation disc with two side surfaces and a circumferential or running surface,
Providing a desired number of, in particular cylindrical, loosening pins
Generating receiving, in particular cylindrical, recesses by erosion and/or drilling methods on one or both side surfaces of the soil cultivation disc, the circumferential shape of the generated receiving recesses corresponding to the circumferential shape of the loosening pins provided, and then
Joining the soil cultivation disc with the pins, wherein the pins are fitted, in particular pressed, into the receiving recesses by form, power or frictional fit.

According to the method, the soil cultivation element and the loosening pins are each provided as individual, separate components. The soil cultivation disc can, for example, be a cast steel or iron part with a very high Rockwell hardness in a range of over 60 HR. Due to the high hardness, the service life of the soil cultivation element can be increased due to less wear. The loosening pins provided can be made from a similar technical material with approximately the same or less hardness and are in particular cylindrical or conical. The hard metal tungsten carbide has proven to be a particularly advantageous technical material. In order to join the provided loosening pins to the soil cultivation disc, the soil cultivation disc is first provided with receiving recesses, in particular in the form of a blind hole, on one or both side surfaces. Due to the high hardness of the material of the soil cultivation disc, the receiving recesses are preferably formed by means of a so-called electro-erosion drilling process (EDM process). Alternatively, the receiving recesses can also be designed in the form of openings, which completely penetrate the soil cultivation element.

The receiving recesses and the loosening pins are designed with the same circumferential shape and preferably with an identical cross section, so that the loosening pins can be pressed and/or hammered into the receiving recesses. If the receiving recesses are continuous, i.e. are designed to completely penetrate the soil cultivation disc, the loosening pins can additionally be welded to the soil cultivation element by setting an argon welding point or, depending on the material, soldered if necessary.

Alternatively, the loosening pins can be joined by means of a so-called high-temperature soldering process using silver, bronze, brass or copper solder and a corresponding flux, which are particularly suitable for high-temperature soldering processes in connection with hard metals, in particular tungsten carbide

Further details, features, (sub)combinations of features, advantages and effects based on the invention emerge from the following description of preferred exemplary embodiments of the invention and the drawings. These show in

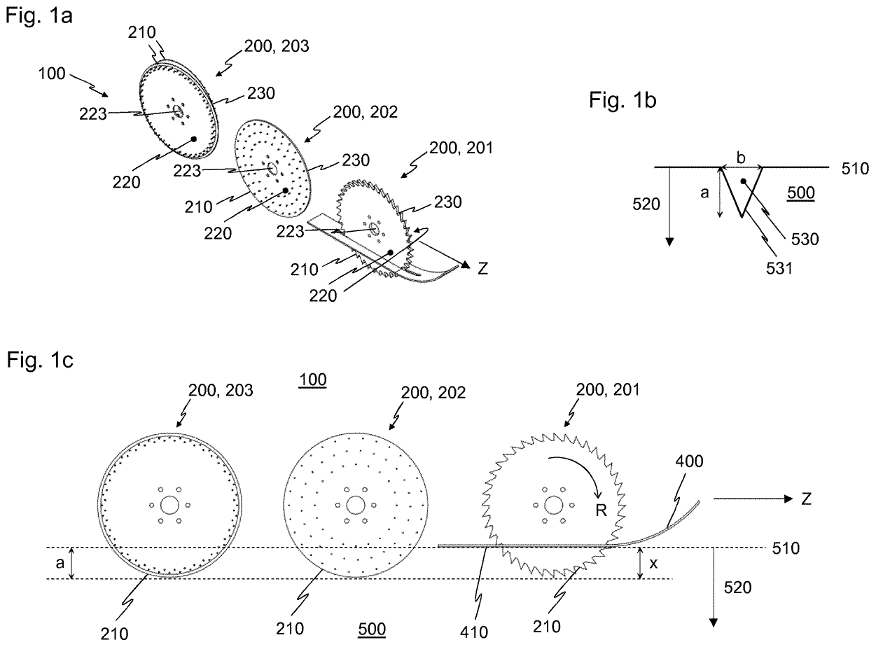

FIG. 1a a schematic perspective illustration of an exemplary embodiment of the soil cultivation arrangement according to the invention with three soil cultivation units arranged one after the other, each designed as a soil cultivation disc,

FIG. 1b a schematic sectional illustration of a seed furrow to be produced in a front view,

FIG. 1c the soil cultivation arrangement from FIG. 1a in a schematic side view,

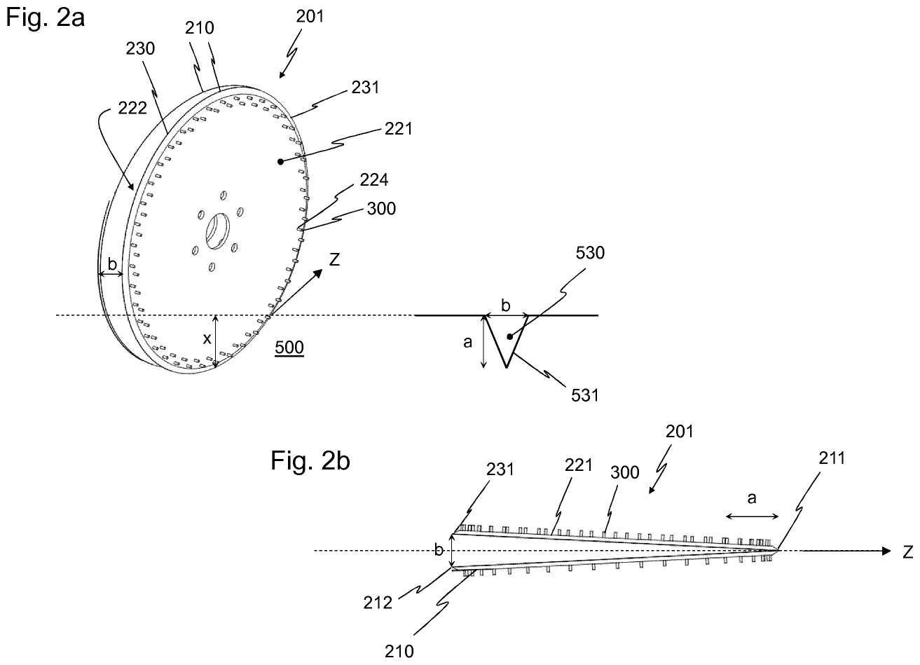

FIG. 2a a schematic perspective illustration of an exemplary embodiment of a furrow opener according to the invention with two soil cultivation discs, together with a schematic sectional illustration of a seed furrow produced therewith in a front view,

FIG. 2b a schematic top view of the furrow opener according to FIG. 2a,

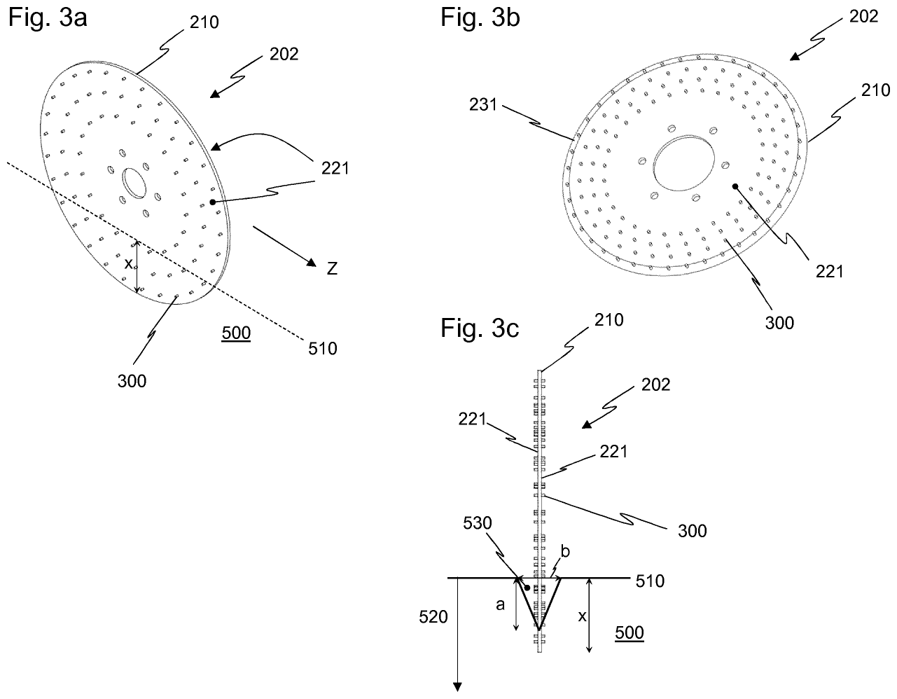

FIG. 3a a schematic perspective illustration of an exemplary embodiment of a soil loosening unit according to the invention with a soil cultivation disc,

FIG. 3b a schematic perspective illustration of a further exemplary embodiment of a soil loosening unit according to the invention with a soil cultivation disc with a cutting edge,

FIG. 3c a schematic front view of the soil loosening unit according to FIG. 3a, together with a schematic sectional illustration of a seed furrow,

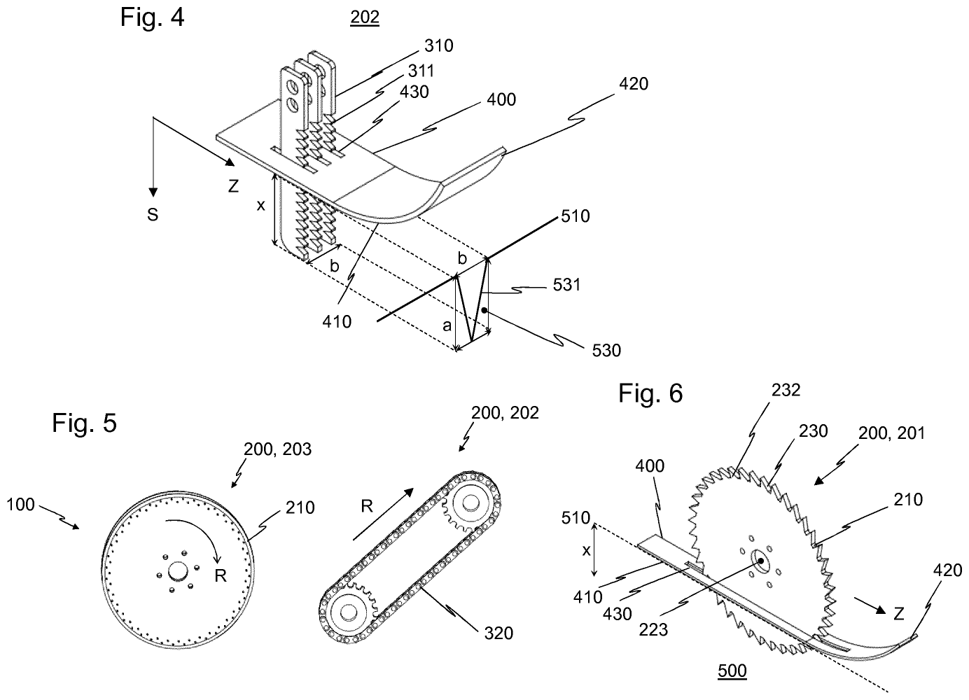

FIG. 4 a schematic perspective illustration of an alternative exemplary embodiment of a soil loosening unit according to the invention with three knives, together with a schematic sectional illustration of a seed furrow to be produced,

FIG. 5 a schematic perspective illustration of a further exemplary embodiment of a soil loosening unit according to the invention with a rotating saw chain and together with a furrow opener,

FIG. 6 a schematic perspective illustration of an exemplary embodiment of a pre-cutter according to the invention with a rotatable mounted knife disk and a sliding device,

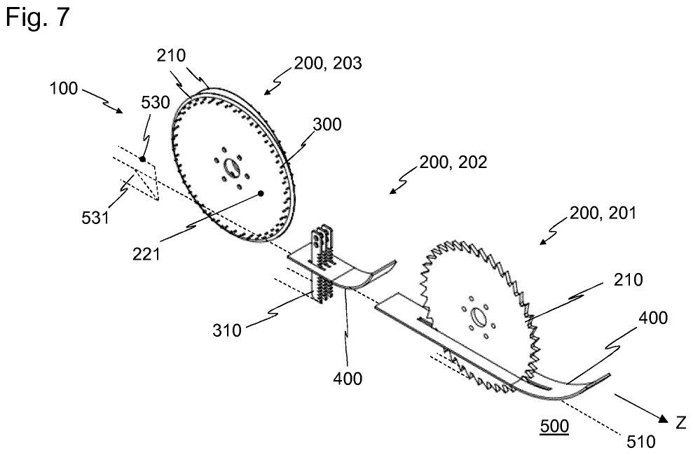

FIG. 7a a schematic side view of a further exemplary embodiment of the soil cultivation arrangement according to the invention with three soil cultivation units arranged one after the other,

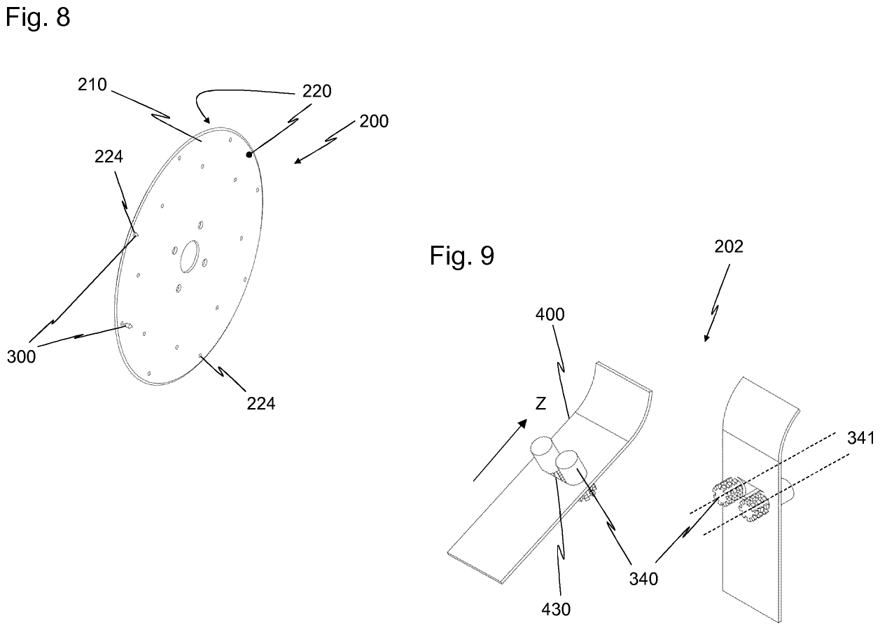

FIG. 8 a schematic perspective illustration of an exemplary embodiment of a soil loosening unit according to the invention with a soil cultivation disc with conical loosening pins,

FIG. 9 two schematic perspective views of an exemplary embodiment of a soil loosening unit according to the invention with two milling heads arranged next to one another and in parallel,

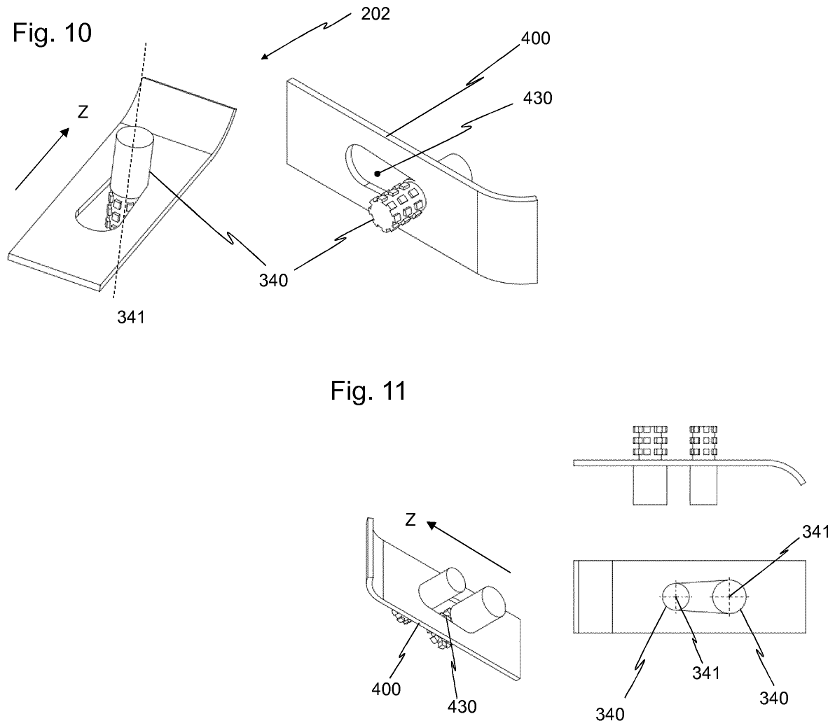

FIG. 10 two schematic perspective views of an exemplary embodiment of a soil loosening unit according to the invention with a single milling head and

FIG. 11 three schematic perspective views of an exemplary embodiment of a soil loosening unit according to the invention with two milling heads arranged one behind the other or in a row.

The figures are merely exemplary in nature and are only used for understanding the invention. The same elements are provided with the same reference symbols, which is why they are usually only described once.

FIG. 1a shows a first exemplary embodiment of a soil cultivation arrangement 100 according to the invention. The soil cultivation arrangement 100 has three soil cultivation units 200, which are modularly connected to a not shown here carrier device of the soil cultivation arrangement 100 in a manner known from the prior art. The carrier device of the soil cultivation arrangement 100 is designed for connection to a tool carrier of an agricultural tractor, also not shown here, in particular a tractor or tug. The soil cultivation units 200 are in turn arranged one after the other along a pulling direction or forward travel direction Z of the agricultural tractor. The soil-cultivation unit 200 arranged foremost in the pulling direction Z has a soil cultivation element 210 in the form of a pre-cutter 201. Likewise, with respect to the direction of pull Z, the pre-cutter 201 is followed by a soil cultivation unit 200 designed as a soil-loosening unit 202. The pre-cutter 201 and the soil-loosening unit 202 are each designed as a single soil cultivation disc. As the rearmost module of the soil cultivation arrangement 100, a soil cultivation unit 200 in the form of a furrow opener or sowing disc 203 follows the soil-loosening unit 202. The furrow opener 203 comprises two soil cultivation discs 210 arranged opposite one another. The soil cultivation disks 210 of the soil cultivation units 200 each have two lateral circular surfaces 220 as well as a circumferential or running surface 230 and are mounted rotatable about their respective axis of rotation 223.

A schematic sectional illustration of a conventional, exemplary seed furrow 530, which can be prepared and produced with the soil cultivation arrangement 100, can be seen in FIG. 1b. The seed furrow 530 is formed with an approximately V-shaped cross-sectional area within the soil 500, more precisely in the uppermost soil horizon 520, and comprises two sloping seed furrow walls 531. The seed furrow depth a is the distance from the soil surface 510 to the deepest point of the seed furrow 530, also known as the furrow base. The seed furrow width b is usually measured in the area of the soil surface 510 and is defined as the distance between the two seed furrow walls 531 in this area. The seed furrow width b is usually in a range between 3.75 cm to 4 cm and the seed furrow depth a in a range between 3 cm to 10 cm. In order to prepare and generate the seed furrow 530, the soil cultivation arrangement 100 is pulled from the agricultural tractor along the pulling direction Z according to FIG. 1a, wherein the rotatable mounted soil cultivation disks usually roll along their respective circumferential or running surface 230 on the soil 500. The pre-cutter 201 and the soil-loosening unit 202 are each provided for preparing the seed furrow 530 and for loosening the soil in the uppermost soil horizon 520, along a cross-sectional area within which the seed furrow 530 is to be created. The actual seed furrow 530 is opened or pulled by means of the following furrow opener 203.

In FIG. 1c, the soil cultivation arrangement 100 from FIG. 1a is shown in a schematic side view. In this illustration, the soil 500 and its soil surface 510 are also indicated schematically. In conservation soil cultivation, the soil 500 is cultivated exclusively within the uppermost soil horizon 520. The soil cultivation units 200, each having one or two soil cultivation discs 210, roll along the soil 500 or on its surface 510 in the roll direction R and penetrate the soil 500, preferably in each case by the same working or penetration depth x, which also roughly corresponds to the seed furrow depth a. Alternatively, and not shown here, it can also be expedient that the pre-cutter 201 and/or the soil loosening unit 202 penetrate deeper into the soil 500, i.e. have a greater working or penetration depth x than the furrow opener 203. This also causes the soil in the area below the seed furrow 530 can be loosened. The working or penetration depth x or seed furrow depth a can be adjusted to the desired amount as required depending on the optimal planting depth of the seed.

For setting the working or penetration depth x, among other things, the pre-cutter 201, for example in the FIG. 1c, has a sliding device 400, the underside sliding surface 410 of which slides on the soil surface 510. By offsetting the soil cultivation disc 210 and the sliding device 400 of the pre-cutter 201 relative to one another, the distance by which the soil cultivation disc protrudes, in particular penetrates, beyond the underside sliding surface 410 and thus its working or penetration depth x can be determined. The sliding device 400 consequently fulfills the function of the devices known from the prior art and optionally also applicable to the invention for setting the working or penetration depth x, such as depth wheels or so-called “chicken feet” and is mounted in a similar manner on a not shown here carrier device of the soil cultivation arrangement 100.

A schematic perspective illustration of an exemplary embodiment of a furrow opener 201 according to the invention together with a schematic, frontal sectional illustration of a seed furrow 530 produced therewith is shown in FIG. 2a. The furrow opener 201 has two soil cultivation disks 210, in particular sowing disks, which are arranged opposite one another and are each set at an angle to the pulling direction Z, whereby the soil cultivation disks 210 enclose an angle in a range between 10.5° and 11.5° with one another. Each soil cultivation disc 210 in turn comprises an outer circular surface 221 which leads in the pulling direction Z, which faces the soil 500 or the respective seed furrow wall 531 to be produced and an opposing inner-side circular surface 222, lagging in the pulling direction Z, which faces away from the soil 500 or the corresponding seed furrow wall 531. Starting from their circumferential or running surface 230, the soil cultivation disks 210 are provided in the radial direction with a cutting edge 231 formed here on one side, along the respective outer circular surface 221. The width of the cutting edge 231 is 10 mm, for example. Also in the area of the outer circumference of the respective soil cultivation disc 210 and adjacent to the cutting edge 231, loosening pins 300 are connected to the respective outer circular surface 221 of the corresponding soil cultivation disc 210. The loosening pins 300 are cylindrical in this embodiment and are arranged alternately along two circumferential or circular paths. The distance between two adjacent loosening pins 300 is in a range between 1 cm and 4 cm. The loosening pins 300 are connected to the outer circular surface 221 via a joining connection, in particular pressed into a receiving recess 224 formed there, and aligned orthogonally to the outer circular surface 221, preferably enclosing an angle of 90° with it.

A schematic top view of the furrow opener 201 is shown in FIG. 2b. It can be seen that the soil cultivation disks 210 are arranged opposite one another and are aligned symmetrically with respect to the pull direction Z. The ends 211 of the soil cultivation discs 210 leading in the pulling direction Z touch each other in a circumferential area of about 4 cm to 5 cm, whereas the trailing ends 212 are arranged at a distance from one another which corresponds approximately to the seed furrow width b. The cutting edge 231, which is embodied all around the outer disk circumference, on the outer circular surface 221 in each case, and is embodied here on one side, can also be clearly seen in this illustration.

In operation, when the agricultural tractor pulls the furrow opener 201 along the pulling direction Z, the soil cultivation discs 210 roll on the ground 500. This way on the one hand the soil is displaced up to the penetration depth x from the outer circular surface 221 to generate the seed furrow 530 with one of the penetration depth x corresponding seed furrow depth a. At the same time, the loosening pins 300, arranged alternately in two rows in this embodiment, are pulled along a respective cycloid, in particular an epicycloid path, through the adjacent seed furrow wall 531. Due to the cycloid, in particular an epicycloid path, the soil is loosened in the area of the complete seed furrow wall 531, whereby a seed furrow wall compaction can be effectively avoided.

An exemplary embodiment of a soil loosening unit 202 according to the invention can be seen in FIG. 3a in a schematic perspective illustration. The soil loosening unit 202 has a single soil cultivation disc 210 which, when the soil cultivation arrangement 100 (see FIG. 1a) is in operation, is aligned parallel to the pulling direction Z and is pulled along it. The soil cultivation disc 210 of the soil loosening unit 202 rolls, as described above, on the soil 500. A circumferential area of the soil cultivation disk 210 defined by the working or penetration depth x penetrates the soil 500, as a result of which a groove-like slot or incision aligned along the pulling direction Z is drawn in the soil 500. Because the soil loosening unit 202 precedes the furrow opener 203 (see FIG. 1a), the creation of the actual seed furrow 530 is prepared and made considerably easier. Because of its parallel alignment, the soil cultivation disc 210 has two outer circular surfaces 221. Orthogonally aligned loosening pins 300 are arranged on both outer circular surfaces 221, which in this embodiment are limited by way of example to the circumferential area of the soil cultivation disc 210 defined by the working or penetration depth x. Alternatively, however, the loosening pins 300 could be arranged also completely distributed over one or both outer circular surfaces 221 of the soil cultivation disc 210. The loosening pins 300 are arranged here in three rows, by way of example, along three circumferential or circular paths, three loosening pins 300 each lying on a common radius of the soil cultivation disc 210. During operation, the soil 500 is loosened by means of the loosening pins 300, which are drawn through the respectively adjacent soil along respective cycloids, in particular epicycloid paths, similar to the previously described for furrow opener 201. In this way, on the one hand, the generation of the seed furrow 530 is facilitated and, on the other hand, compaction of the seed furrow wall is prevented.

FIG. 3b shows an alternative exemplary embodiment of a soil loosening unit 202 according to the invention with loosening pins 300 arranged along a total of four circumferential or circular paths. The soil loosening unit also has a circumferential cutting edge 231, which here is formed in particular on both sides, on both outer circular surfaces 221.

FIG. 3c shows a front view of the soil loosening unit 202 according to FIG. 3a, shown along the pulling direction Z, together with a schematic, frontal sectional view of a seed furrow 530 to be generated. The loosening pins 300 arranged on both sides can be clearly seen here. They are arranged orthogonally to the respective outer circular surface 221 and are connected to it. Alternatively, an embodiment variant (not shown) would also be possible in which loosening pins 300 penetrate the soil cultivation disc 210 of soil loosening unit 202 and protrude from soil cultivation disc 210 on both outer circular surfaces 221. In addition, it is shown in this embodiment that the working or penetration depth x exceeds the seed furrow depth a of the seed furrow 530 to be formed with the following furrow opener 203, which also loosens the soil below the seed furrow 530 or prevents soil compaction in the area of the furrow bottom.

A schematic perspective illustration of an alternative exemplary embodiment of a soil cultivation unit 200 according to the invention with a soil cultivation element 210 designed as a soil loosening unit 202 can be seen in FIG. 4, together with a schematic section of a seed furrow 530 to be generated. The embodiment of the soil loosening unit 202 shown here is designed with a total of three knives 310, which are provided with a saw profile 311 in the pulling direction Z and can be moved up and down linearly in translation along a cutting direction S running orthogonally to the pulling direction Z. The soil loosening unit 202 also has a sliding device 400, the sliding surface 410 of which is provided for sliding on the soil surface 510. A front section 420 of the sliding device 400 in the pulling direction Z is raised in the manner of a runner with respect to the ground surface 510 in order to facilitate sliding off even on uneven ground. Three slot-like recesses 430 of the sliding device 400, arranged parallel to one another, are each penetrated by one of the knives 310. At the same time, function as a kind of guide in the cutting direction S. The sliding device 400 can be used to variably set the working or penetration depth x of the knives 310. In addition, the sliding device 400 prevents plant or root residues from being pulled out of the soil. The set working or penetration depth x preferably corresponds to the seed furrow depth a, and the distance between the two outer knives 310 corresponds to the seed furrow width b of the seed furrow 530 to be generated. As can be seen from the schematic sectional view of the seed furrow 530, the embodiment of the soil loosening unit 202 shown here loosens the soil 500 transversely to the direction of pull Z along a rectangular cross-sectional area. The V-shaped cross-sectional area of the seed furrow 530 protrudes, in particular in the area of the seed furrow walls 531, which effectively prevents soil compaction here. The knives 310 can be driven electrically, hydraulically, pneumatically or mechanically via a conventional linear actuator and are mounted, preferably spring-loaded and/or with clearance, so that they can move up and down along the cutting direction S.

FIG. 5 shows a schematic perspective illustration of a further exemplary embodiment of a soil cultivation arrangement 100 with two soil cultivation units 200. The soil cultivation arrangement 100 has the soil cultivation unit 200 designed as a furrow opener or as a seeding disc 203 and a preceding soil cultivation unit 200 with a soil cultivation element 210 designed as a soil loosening unit 202, which is constructed with a revolving soil cultivation chain 320. The furrow opener 203 corresponds to the embodiment shown in FIGS. 2a, b and is therefore not explained again in the following. The soil loosening chain 320 of the soil loosening unit 202 is preferably driven electrically, hydraulically, pneumatically or mechanically via an actuator and is attached to the carrier device of the soil cultivation arrangement 100. If necessary, it can circulate, “forwards” in the rolling direction of the soil cultivation discs of the furrow opener 203 or “backwards” in opposite to the direction of rotation R indicated schematically. The soil loosening chain 320 is preferably provided, at least in sections, with a saw tooth profile, not shown here, the teeth of which extend straight or obliquely, in particular radially, outward, in the direction of the soil 500. Optionally the soil loosening unit 202 having the soil loosening chain 320 has a sliding device 400 according to FIGS. 1a, c, for setting the working or penetration depth x.

A soil cultivation element 210, embodied as a pre-cutter 201, of an exemplary soil cultivation arrangement 100 can be taken from FIG. 6, for example, in a schematic perspective illustration. The pre-cutter 201 comprises a single soil cultivation element 210, which is mounted rotatable around its axis of rotation 223 and is aligned parallel to the pulling direction Z. Here it is projected as a circular saw-like knife disc for cutting plant and root residues, as well as for preparing the seed furrow 530 to be produced. Along the circumferential or running surface 230, the soil cultivation disc 210 is provided with a tooth profile 232 pointing radially outward, which through the rotation of the soil cultivation disc 210, cuts plant or root residues present on the soil surface 510 or in the soil 500. In order to make it easier to shear off plant or root remains, the pre-cutter 201 is therefore additionally designed with a sliding device 400, the front section 420 of which is raised in a runner-like manner with respect to the ground surface 510. The soil cultivation disc penetrates a centrally arranged and elongated slot-like recess 430 of the sliding device 400. During operation of the soil cultivation arrangement 100, the pre-cutter 201 is moved along the pulling direction Z, whereby the sliding device 400, with its underside sliding surface 410, slides along the soil surface 510 and holds down any plant residues. At the same time, the sliding device 400 prevents any root residues located in the soil 500 from being pulled out of the soil 500 by the rotating soil cultivation disc 210. In addition, the sliding device 400 is used to set the working or penetration depth x.

Finally, a further exemplary embodiment of a soil cultivation arrangement 100 according to the invention is shown in a schematic perspective illustration in FIG. 8. The soil cultivation arrangement 100 comprises three soil cultivation units 200, which are designed as a pre-cutter 201, a soil loosening unit 202 and a furrow opener 203. The pre-cutter 201 has a single soil cultivation disc 210 and a sliding device 400. With regard to the pulling direction Z, the soil loosening unit 202 is arranged following the pre-cutter 201 and likewise comprises a sliding device 400, which, however, is penetrated by three knives 310 which can be moved up and down transversely to the pulling direction Z. The furrow opener 203 is arranged with two soil cultivation discs 210 each oriented at an angle to the pulling direction Z, terminating in the pulling direction Z or following the soil loosening unit 202.

During operation, i.e. when an agricultural tractor pulls the soil cultivation arrangement 100 in the pulling direction Z, plant and root residues can first be cut above and below ground by means of the pre-cutter 201, with an incision in the soil 500 leading to the seed furrow 530 being produced at the same time. By means of the soil loosening unit 202 provided with three knives 310, the soil 500 is then loosened in the area of the seed furrow 530 to be generated. In this embodiment the rectangular cross-sectional area of the soil 500 loosened with the soil loosening unit protrudes the V-shaped cross-sectional area of the seed furrow 530, in particular in the area of the seed furrow walls 531. As a result, the soil is loosened extensively around the seed furrow 530 to be produced, so that compaction of the soil 500 in the region of the seed furrow walls 531 is effectively prevented. Finally, the furrow opener 203, the surrounding soil being displaced laterally in the manner of a plow by the inclined tillage discs 210, draws the actual seed furrow 530. In order to prevent the inevitably occurring compression in the area of the seed furrow walls 531 during this work step, the soil cultivation discs 210 are each provided with the loosening pins 300 on their outer circular surface 221. During the generation of the seed furrow 530 they are drawn along a respective cycloid, in particular an epicycloid path through the soil adjacent to the seed furrow walls 531 and loosen them up.

FIG. 8 shows an alternative, exemplary embodiment of a soil loosening unit 202 according to the invention in a schematic perspective illustration. The soil loosening unit 202 comprises a soil cultivation disc 210 which is provided on both sides with loosening pins 300 which are here conically formed. As an example, only two loosening pins 300 are shown in the illustration, one of the loosening pins 300 being arranged ready for use within a receiving recess 224 that penetrates the soil cultivation disc 210, so that the tapered tips of the loosening pin 300 each protrude beyond the two circular surfaces 220 of the soil cultivation disc 210. A second loosening pin 300 is shown in an exploded view of the soil cultivation disc 210, so that it's central, cylindrical section and the two conically tapering tips can be seen. To fasten the loosening pins 300 within the soil cultivation disks 210 or within the respectively assigned receiving recess 224, the loosening pins 300 are first inserted into the corresponding receiving recesses 224 up to the desired position and attached to both circular surfaces 220 of the soil cultivation disk 210 by means of soldering using a hard solder.

Two schematic perspective views of an exemplary embodiment of a soil loosening unit 202 according to the invention comprising two milling heads 340 arranged next to one another in the pulling direction or forward travel direction Z with axes of rotation 341 aligned parallel to one another can be seen in FIG. 9. Depending on the depth of the seed furrow to be produced, however, more than two milling heads 340 can also be arranged next to one another. For depth control, the soil cultivation unit shown in FIG. 9 is provided with a sliding device 400, which is designed with one or more recesses 430 through which the milling heads 340 pass. Alternatively, the sliding device 400 can also be renounced.

FIG. 10 shows two schematic perspective views of a further exemplary embodiment of a soil loosening unit 202 according to the invention with a single milling head 340. The milling head 340 or its axis of rotation 341 is arranged here centrally within an optional sliding device 400 and penetrating a recess 430 provided therein. Alternatively, according to FIG. 11, two or more milling heads 340 can also be arranged one behind the other or in a row with respect to the pulling direction or forward travel direction Z. When using several milling heads 340 arranged one behind the other, it has been found to be advantageous to design them with different diameters, the milling head 340 arranged at the front in the forward travel direction Z expediently having the smallest diameter and the milling head 340 arranged at the rear having the largest diameter.

The respective milling heads 340 of the previously described embodiments according to FIGS. 9, 10 and 11 are driven by one or more drive units, not shown here, which are preferably designed as an electrically, pneumatically, mechanically or hydraulically driven rotary actuator. By means of the drive unit and, if necessary, interposed gear elements, the milling heads 340 can be rotated around their respective rotational axis 341 at the desired speed in the same or opposite direction of rotation. The chosen arrangement of the milling heads 340, i.e. a single milling head 340, two or more milling heads 340 next to one another and/or two or more milling heads 340 one behind the other can, if necessary, be adapted to the prevailing soil conditions.

### LIST OF REFERENCE SYMBOLS

100 soil cultivation arrangement

200 soil cultivation unit

201 pre-cutter

202 soil loosening unit

203 furrow opener

210 soil cultivation disc

211 leading end

212 trailing end

220 circular surface

221 outside circular surface

222 inside circular surface

223 axis of rotation

224 receiving recesses

230 circumferential or running surface

231 cutting edge

232 tooth profile

300 loosening pins

310 knives

320 soil loosening chain

330 teeth

340 milling head

341 axis of rotation

400 sliding device

410 sliding surface

420 front section

430 recess

500 soil

510 soil surface

520 top soil horizon

530 seed furrow

531 seed furrow wall

x working or penetration depth

a seed furrow depth

b seed furrow width

Z direction of pull or forward direction of travel

R direction of rotation

S cutting direction

1. A soil cultivation arrangement (100), for agricultural cultivation of a soil (500), with a carrier device for attaching to an agricultural tractor and with one or more soil cultivation units (200, 201, 202, 203) for preparation of or to generate a seed furrow (530) the soil cultivation units (200, 201, 202, 203) being modular components of the soil cultivation arrangement (100) and connectable to the carrier device or to a sowing unit that can be towed by the agricultural tractor and can be arranged along the carrier device in the desired sequence.

2. A soil cultivation arrangement (100) according to claim 1,
characterized in that
at least one soil cultivation unit (200, 201, 202, 203) comprises one or more soil cultivation disks (210), which are mounted rotatable around an axis of rotation (223) for rolling on the soil (500), which on at least one are provided axial loosening pins (300), which loosening pins (300) are designed to loosen the soil (500) in the area of the respective seed furrow wall (531).

3. A soil cultivation arrangement (100) according to claim 2,
characterized in that
the one or more soil cultivation disks (210) are provided on an outer circular surface (221) with the loosening pins (300) by means of a joint connection and the loosening pins (300) are aligned orthogonally to the respective outer circular surface (221).

4. A soil cultivation arrangement (100) according to claim 2,
characterized in that
the one or more soil cultivation disks (210) have a cutting edge (231) which, starting from the outer disk circumference of the respective soil cultivation disk (210), is formed along the outer circular surface (221), and extends in the direction of the axis of rotation (223) of the soil cultivation disk (210).

5. A soil cultivation arrangement (100) according to claim 2,
characterized in that
at least one soil cultivation unit (200) is designed as a furrow opener (203) with two rotatable mounted soil cultivation disks (210), at least one of the soil cultivation disks (210), which is for generating the seed furrow (530), is arranged at an angle to a pulling direction or forward travel direction (Z) of the agricultural tractor and the respective outer circular surface (221), and is provided with the loosening pins (300).

6. A soil cultivation arrangement (100) according to claim 2,
characterized in that
at least one soil cultivation unit (200) is designed as a soil loosening unit (202) with a single rotatable mounted soil cultivation disk (210), the soil cultivation disk (210) which is for loosening the soil (500) and for preparing the seed furrow (530), is provided with the loosening pins (300) on one or both of the outer circular surface (221) facing the seed furrow wall (531).

7. A soil cultivation arrangement (100) according to claim 1,
characterized in that
at least one soil cultivation unit (200) has a runner-like sliding device (400), on the underside of which, facing the soil (500), a sliding surface (410) is designed to slide on a soil surface (510).

8. A soil cultivation arrangement (100) according to claim 7,
characterized in that
one or more soil cultivation disks (210) protrude the sliding surface (410) of the sliding device (400) by a variably adjustable working or penetration depth (x).

9. A soil cultivation arrangement (100) according to claim 7,
characterized in that
at least one soil cultivation unit (200) is designed as a pre-cutter (201) with a single rotatable mounted soil cultivation disk (210), the soil cultivation disk (210), which is for cutting plant and root remains and for preparing the seed furrow (530), is provided with a radially extending tooth profile (232) along its outer circumferential or running surface (230).

10. A soil cultivation arrangement (100) according to claim 7,
characterized in that
at least one soil cultivation unit (200) is designed as a soil loosening unit (202) with one or more knives (310), which are for cutting plant and root residues, loosening the soil (500) and preparing the seed furrow (530), are movable translationally to the pulling direction or forward travel direction (Z) of the agricultural tractor.

11. A soil cultivation arrangement (100) according to claims 10,
characterized in that
the one or more knives (310) of the soil loosening unit (202) are arranged to penetrate a slot-like recess (430) of the sliding device (400), with each knife (310) preferably being assigned a respective slot-like recess (430).

12. A soil cultivation arrangement (100) according to claim 1,
characterized in that
at least one soil cultivation unit (200) is designed as a soil loosening unit (202) with a revolving soil loosening chain (320), the soil loosening chain being used for cutting plant and root residues, for loosening the soil (500) and for preparing the seed furrow (530) to be produced in the manner of a motorized chain saw driven by an actuator and has a saw tooth profile.

13. A soil cultivation arrangement (100) according to claim 1 and further comprising a furrow opener (203) for connection to a carrier device of the soil cultivation arrangement (100)
characterized in that
the furrow opener (203) having two rotatable mounted soil cultivation disks (210) whereby the soil cultivation disks (210) enclose an acute angle with one another for generating a seed furrow (530) in a pulling direction or forward travel direction (Z) of an agricultural tractor, the soil cultivation disks outer circular surfaces (221) are axially provided with loosening pins (300), which loosening pins (300) are designed to loosen the soil (500) in the area of the respective seed furrow wall (531).

14. A soil loosening unit (202) for connection to a carrier device of a soil cultivation arrangement (100) according to claim 1,
characterized in that
the soil loosening unit (202) has one or more knives (310) which are used for cutting plant and root residues, for loosening the soil (500) and for preparing a seed furrow (530) and are moved translational to the pulling direction or the forward direction of travel (Z) of an agricultural tractor.

15. A soil loosening unit (202) for connection to a carrier device of a soil cultivation arrangement (100) according to claim 1
characterized in that
the soil loosening unit (202) is designed with a revolving soil loosening chain (320) which is actuated and driven in the manner of a motorized chain saw for cutting plant and root residues, loosening the soil (500) and preparing a seed furrow (530) and is formed with a saw tooth profile.

16. A soil cultivation arrangement (100) according to claim 1 and further comprising a pre-cutter (201) for connection to a carrier device of the soil cultivation arrangement,
characterized in that
the pre-cutter (201) has a runner-like sliding device (400) with a soil-facing underside having a sliding surface (410) designed to slide on a soil surface (510) and has a single, rotatable mounted soil cultivation disk (210), the soil cultivation disk (210), being for cutting plant and root remains and for preparing the seed furrow (530), and provided with a radially extending tooth profile (232) along its outer circumferential or running surface (230).

17. A method for producing a soil cultivation disk (210) for a soil cultivation unit (200) for connection to a carrier device of a soil cultivation arrangement (100),
characterized by the following steps:
Providing a soil cultivation disk (210) with two lateral circular surfaces (220) and a circumferential or running surface (230),
Providing a desired number of loosening pins (300),
Generating receiving recesses (224) on one or both circular surfaces (220) of the soil cultivation disk (210) by erosion or drilling processes, whereby the circumferential shape of the generated receiving recesses (224) correspond to the circumferential shape of the loosening pins (300), and subsequently
Joining the soil cultivation disk (210) with the loosening pins (300), wherein the loosening pins (300) being fitted into the receiving recesses (224) by form, power or frictional fit.
